(19) United States
(12) Patent Application Publication
(10) Pub. No.: US 2004/0191396 A1
(43) Pub. Date: Sep. 30, 2004

(54) Flax sprouts and sprouting method

(76) Inventor: Dennis Barker, Shannonville (CA)

Correspondence Address: Borden Ladner Gervais LLP, 1100-100 Queen Street, Ottawa, ON, K1P 1J 9, CA

(21) Appl. No.: 10/751,634

(22) Filed: Jan. 6, 2004

Related U.S. Application Data
(63) Continuation of application No. PCT/CA02/01030, filed on Jul. 8, 2002.
(60) Provisional application No. 60/303,079, filed on Jul. 6, 2001.

(51) Int. Cl. A23L 1/36

(52) U.S. Cl. 426/629

(57) ABSTRACT

A process for sprouting flaxseed is provided in which wet flaxseeds are agitated vigorously and allowed to sprout under a controlled moisture environment using a plurality of discreet water additions. The sprouts formed exhibit enriched Omega-3 fatty acid content compared to whole flaxseed, and may be eaten fresh or dried. A dried sprout product may be formed from other seed types by sprouting to a length of less than about three times the length of the whole seed, and subsequently drying and grinding the sprout. Flaxseeds may be co-sprouted with other seeds such as fenugreek, soy, red clover, alfalfa, radish, garlic, mustard, onion, broccoli, alfalfa, canola, other brassica family plants, and combinations of these.

### CROSS REFERENCE TO RELATED APPLICATIONS

This application is a continuation of PCT Application PCT/CA02/01030 filed on Jul. 8, 2002 which claimed priority from U.S. Provisional Patent Applications Serial No. 60/303,079 filed Jul. 6, 2001.

### FIELD OF THE INVENTION

The present invention relates to the field of nutrition, and more specifically to the production of sprouts from flaxseed.

### BACKGROUND OF THE INVENTION

The impact of flaxseed on the world's food supply is increasing. Nutritionally enhanced eggs from hens fed flaxseed are available in North and South America, Europe and Asia. Flax has gained ever-increasing notoriety as a bakery ingredient, especially in multigrain breads and bagels. In Germany, there are reports that more than 60,000 tonnes of flaxseed are consumed annually in breads and cereals (Eibebsteiner, Trends In Flax Baked Goods. In: Flax: An Expanding Future Conference. Proc. Flax Council of Canada. Winnipeg, MB. 1993;April 13:23-31)

Health conscious consumers increase the demand for flax-enriched foods as they become more educated on the potential benefits of flaxseed in reducing the risk of chronic diseases such as cancer and coronary heart disease.

Flax, or Linum usitatissimum of the family Lincaea, is an acknowledged source of nutritive and non-nutritive plant substances. Flaxseed is rich in protein, Omega-3 fatty acid (especially alpha-linolenic acid), soluble and insoluble dietary fibre and lignans. Flaxseed is long recognized as a food with the potential to help reduce the risk of chronic disease.

The amino acid pattern of flaxseed protein is similar to that of soybean protein, which is viewed as one of the most nutritious of the plant proteins. The alpha-linolenic acid (ALA) in flaxseed is of increased interest clinically for the role it may play as a precursor of hormone-like substances which are involved in many biological functions in the body (Simopoulos, Omega-3 Fatty Acids In Health And Disease And In Growth And Development. Amer. J. Clin. Nutr. 1991;54:438-463. Both soluble and insoluble forms of fiber are found in flaxseed. Soluble and insoluble fibers are of interest for their functional properties as food ingredients and for their physiological effects on hyperlipidemia and atherosclerosis (Kritchevsky, Fibre Effects Of Hyperlipidemia. In: Flaxseed in Human Nutrition, Eds. S.C. Cunnane and L.U. Thompson. AOCS Press. Champain, Ill., 1995 pp. 174-186). Plant lignans are phenolic compounds, many of which are biologically active phytochemicals with apparent anti-cancer properties. The fibre fraction of flaxseed is a rich source of a lignan precursor called secoisolariciresinol diglycoside (SDG) providing 75-800 times more plant lignans than most foods (Thompson, Flaxseed, Lignans and Cancer. In: Flaxseed in Human Nutrition. Eds. S.C. Cunnane and L.U. Thompson. AOCS Press. Champaign, Ill. 1995 pp. 219-236).

There are a number of nutraceutical compounds such as Omega-3 and Omega-6 fatty acids that have been shown to be highly beneficial for human and animal health. Beneficial nutraceuticals such as Omega3 fatty acids are found in cold marine fish, algae, certain plants and oils or by products from such sources.

Examples of beneficial fatty acids include docasahexaenoic acid (DHA), and eicosapentenoic acid (EHA), or precursors such alpha-linolenic acid (ALA). These fatty acids are linked to a wide variety of beneficial health effects in intervention studies as essential constituents of cells, especially brain cells, nerve relay, retina, adrenal glands, and reproductive cells. Long chain polyunsaturated fatty acids (LCPs) such as DHA/EPA have health benefits for the heart, skin, immune and inflammatory diseases, attention deficit disorders reduction of stress and infant development. Some studies suggest a beneficial role of LCPs in preventing Alzheimer's dementia and colorectal cancers.

The chemical structures of DHA, EPA, ALA, CLA are well known and documented. However, the metabolism of these compounds can vary depending on their bioavailability and level in foods. ALA, for example, can only be converted to DHA to a limited extent, for example in the order of 0-15% depending on individual metabolism, source and amount of ALA present. Moreover, ALA from plants such as flax can be highly unstable in processed fractions, such as oil, and may be of questionable quality.

There is an established body of literature outlining the benefits of Omega-3 fatty acids present in food and food supplements. Patents have been granted for a variety of inventions relating to the enrichment of foods that are normally low or deficient in Omega-3 fatty acids or LCPs. For example, U.S. Pat. No. 5,832,257 (Wright et al.) relates to DHA being produced in cow's milk through the feeding of cold marine fish meal to cows, using a feather meal based feed supplement. However, these feed formulas have a number of deficiencies on a practical basis. For example, fishmeal can be considered unsuitable for organic use and can be a feeding deterrent to livestock such as cows, and only limited amounts of DHA can be achieved in the milk.

It is known that using flax meal or algae/DHA as feed supplements for chickens can elevate the Omega-3 content of eggs. However, in the case of flax-based poultry and animal feeds, flax is converted only on a limited basis into DHA/EPA due to the limited amount (14-15% by weight) of ALA in whole or ground seed. Most of the ALA passes from the flax in an unaltered long chain polyunsaturated form.

U.S. Pat. No. 5,069,903 describes an edible flaxseed composition comprised of grounded raw flaxseed. However, flax in the case of most livestock feeds also acts as a laxative and can be a feeding deterrent. Although flaxseed is a highly concentrated source of ALA, whole flax or ground seeds pass through the body almost entirely unconverted. Ground flaxseed or oil on the other hand can rapidly lose its ALA content and may not store well or be useful as a food ingredient in terms of ALA content.

As food ingredients, Omega-3 and Omega-6 fatty acids occur at various levels in certain plant species such as flax, or as DHA/EPA concentrates from marine animals or cold water fish/algae. However, both flavor and stability problems have prevented these sources from being of practical use as sources of Omega-3 and Omega-6 fatty acids in foods to enrich foods, improve processing, shelf life or to provide anti-bacterial properties/benefits. Flax-derived products and Omega-3 supplemented foods currently on the market require refrigeration and generally require immediate usage to prevent spoilage.

Although the anti-microbial and anti-inflammatory properties of Omega-3 and Omega-6 fatty acid sources are not well understood, the literature suggests a role for these fatty acids in shelf-life extension and maintenance of good health for the consumer.

It is therefore desirable to provide a plant-based product which is stable and contains Omega-3 fatty acids, and other nutritionally beneficial components. It is also desirable to provide processes for forming such products. Further, there is a need for Omega-3 containing products having a long shelf life. Additionally, there is a need for a process for producing a dried product from sprouted seeds of all types.

### SUMMARY OF THE INVENTION

The invention relates to a food product and a process for its preparation.

According to the invention, there is provided a method for production of flax sprouts with elevated Omega-3 content compared with whole flaxseed alone. The product may also exhibit higher levels of other nutritional components. The ALA content of the inventive product may be increased relative to the content found in flaxseed, as may be the level of other nutritionally beneficial components.

The invention provides a process for preparing flax having an elevated level of an Omega-3 fatty acid compared to flaxseed, comprising the step of sprouting flaxseed for at least 6 hours. The invention also relates to a process for sprouting flaxseed where the flaxseed is germinated by hydration with a plurality of separate additions of water, agitating flaxseed between additions of water, and permitting sprouting for at least 6 hours.

The invention provides a process of preparing a flax product comprising the steps of sprouting flaxseed by hydrating with a plurality of discreet additions of water, drying the sprout to a moisture content of less than about 5%, and milling the dried sprout at a temperature below 65° F. As a general process that can apply to any type of sprouting seed, the process of preparing a dried sprout product comprises the steps of sprouting a seed to a point where the sprout is less than about 3 times the length of an unsprouted seed, drying the sprout to a moisture content of less than about 5%, and nilling the dried sprout at a temperature below 65° F.

Additionally, the invention provides a flax product having a higher level of an Omega-3 fatty acid compared to flaxseed, the product comprising flaxseed sprouted for at least 6 hours.

Advantageously, the sprouted flax product formed according to the invention is a stable product containing Omega-3 fatty acids and other nutritionally beneficial components. The product formed according to the invention has a long shelf life that permits storage over a considerable period of time. In some embodiments, the product requires no refrigeration and has a shelf-life in excess of one year. The inventive product also exhibits anti-bacterial effects. Further, some health benefits, such as anti-inflammatory and other regulatory effects on metabolism may be imparted by the product according to the invention.

The product formed according to the invention has the further advantage that it can be included in food products that are highly acceptable to the consumer. Food products according to the invention have no off-flavoring or distortion of recipes. The invention results in higher quality baked products compared to products formed from conventionally prepared milled flax.

The inventive process of preparing a dried sprout product from any seed type has the advantage that the product formed is highly acceptable to the consumer, and the nutritional content of fresh sprouts is highly preserved in the dried product.

### BRIEF DESCRIPTION OF THE DRAWINGS

Embodiments of the present invention will now be described, by way of example only, with reference to the attached Figures, wherein:

FIG. 1 is a table exhibiting compositional analysis for sprouts and sprout combinations formed according to the invention.

FIG. 2 is schematic diagram illustrating a process for sprouting flaxseed according to the invention.

FIG. 3 provides a compositional profile for sprouted flax powder formed according to an embodiment of the invention.

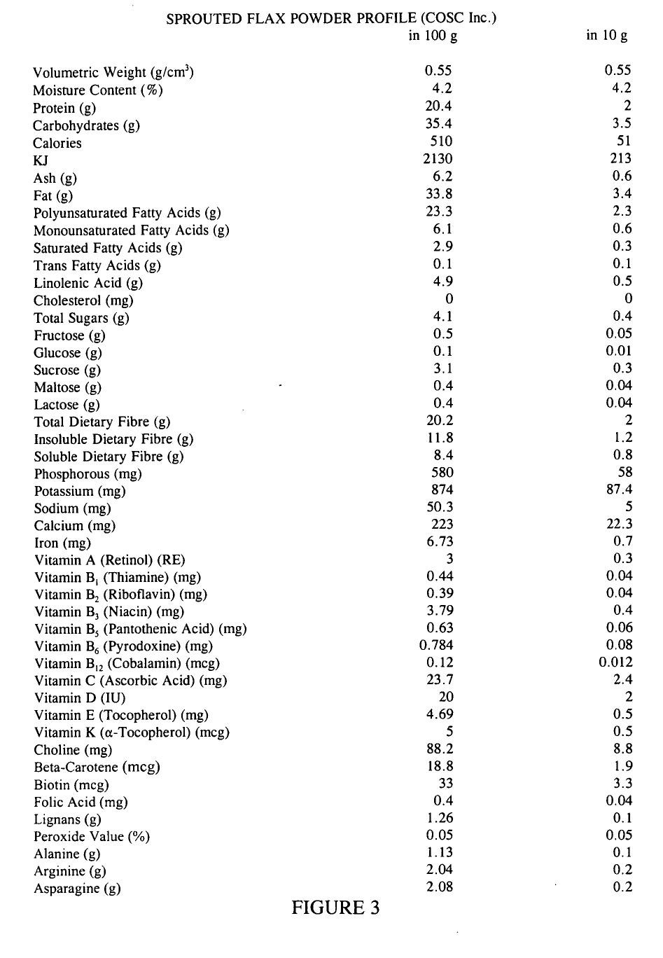

FIG. 4 provides a compositional profile for sprouted flax powder formed according to the invention, including bluebarry:flax powder and cranberry:flax powder mixtures (1:3 ratio), and the berry powder itself for comparison.

FIG. 5 provides an amino acid profile comparing flaxseed and sprouted flax powder formed according to the invention.

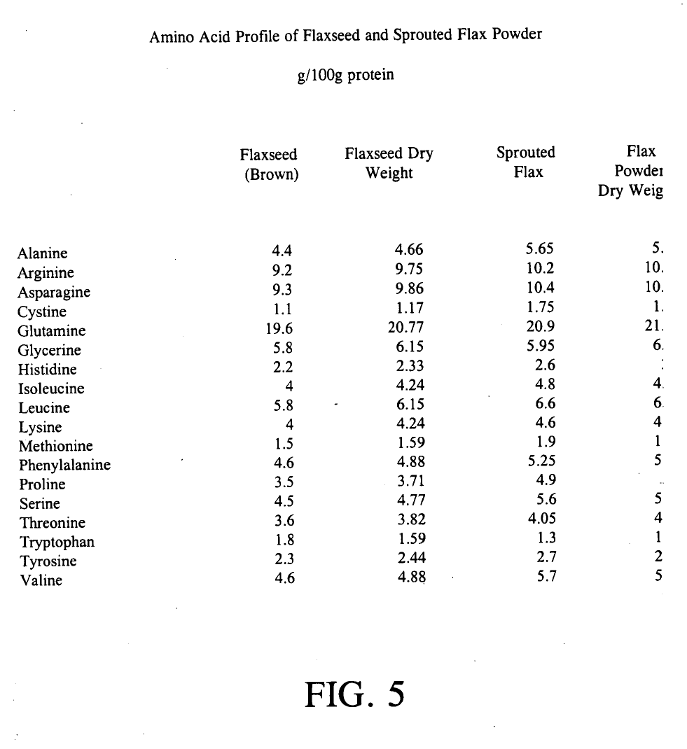

FIG. 6 illustrates a comparison of lignan content in the sprouted flax and sprouted flax powder formed according to the invention versus other foods, including flaxseed.

### DETAILED DESCRIPTION

The present invention provides for the production of a food product using a sprouting process. The production of sprout-containing processed foods with improved features or health benefits can also be achieved by blending the sprouts, powders or extracts formed according to the invention with processed foods so as to form Omega-3 fatty acid enriched functional foods.

Nutraceuticals are considered herein as components extracted from a plant or foods, the extracted component having a real or perceived health-related benefit.

Functional foods are considered herein to be foods containing a supplemented component offering or real or perceived health benefits. The supplemented component of a functional food may be a nutraceutical component or any other type of natural or synthetic supplement.

General Methodology. The general methodology for sprouting flaxseed according to the invention is provided below. Specific examples follow, which incorporate particular time periods, temperatures, etc. However, for purposes of the invention, the general methodology may be adapted with minor variations, as would be apparent to those of skill in the art.

The general methodology covers all aspects of sprout or flax sprout production, at every stage from seed selection to packaging to formation of baked goods. Of course, not all aspects of the general methodology are required to fall within the scope of the invention. Those steps of the general methodology which are optional to the invention are identified as such.

Seed selection is initially conducted as an optional aspect of the invention. Of course, any type of seed that sprouts may be used. For flaxseed selection, one optional criteria is that the seed be “organic”, as defined popularly to mean pesticide-free. The seed is optimally of uniform density, unbroken, non-discolored, mold-free, and should have a germination rate of approximately 98%, as determined in advance of conducting the sprouting methodology. When other types of seed are selected either for use alone or in combination with flaxseed, similar criteria may be applied.

Seeds hydration may be conducted in a variety of different ways. The general case may be varied, depending on the conditions under which the sprouting is to occur. The process outlined herein is optimal for flaxseed and flaxseed mixtures, but need not be followed stringently for sprouting other types of seeds which are not combined with flax. For other seed types, the sprouting process may follow conventional sprouting methodologies. However, when flaxseed is present, the methodology for hydration as outlined herein should be used.

Initially, the selected seed is spread out in a thickness of about 2 to 5 inches in depth. A range of 2.5 to 4.5 inches is preferable, and a seed thickness of from 3 to 4 inches deep is typical. This allows the core of the seed thickness to achieve a temperature of about 100° F. from the exothermic energy released upon germination. The seed may be spread over a large or small area, such as a tray or pan.

Once the seeds are spread out with an appropriate thickness, water is added to begin the sprouting process. A low moisture content is used over a short duration of time with a high temperature, low humidity, and with regular blending or agitation. The water is added to the seed in a plurality of separate additions, for example with between 2 to about 20 separate additions of water over a selected time period. Water may be added over exemplary time periods, such as from 2 to 12 hours, more preferably from 3 to 10 hours, for example, over 8 hours.

Water additions may be made periodically, for example every hour or every two hours, followed by agitation for a period of time adequate to distribute the water throughout the seeds. Agitation may be done at a relatively slow rate, such as from 5 to 100 rpm. The agitation period may be from about 2 minutes to about 15 minutes, for example, for 10 minutes after each subsequent addition of water.

A typical schedule for water addition is provided as follows for a weight of about 10 pounds (4.54 kg) of seed. Four separate additions of water are added, with a total amount of water added being 4.5 liters. In the first hour, 0.5 liter of water is added to the seed and mixed for 10 minutes. The seed is allowed to sit for the remainder of the first hour. At the start of the second hour, a liter of water is added, the seed is agitated for 10 minutes, and the seed is allowed to sit for the remainder of the second hour. At the start of the third hour, 1 liter of water is added and the seed is agitated for 10 minutes. The seed is then allowed to sit for the remainder of the third hour, as well as for the subsequent fourth hour. At the start of the fifth hour, a subsequent 1 liter addition of water is combined with the seed, with about 10 minutes of agitation, and the seed is allowed to sit for the remainder of the fifth hour, as well as for the following 3 hours, for a total of 8 hours. A final addition of 1 liter of water may be added and the mixture agitated for 10 minutes, for a total of 4.5 liters of water total. Sprouts may then be permitted to grow to the required size.

Of course, for flaxseed or flaxseed blends, any variation of this process is encompassed which allows for subsequent additions of water to be added at periodic intervals with mixing, so as to avoid the seed turning into a hard, paste-like clump. Part of the difficulty with using conventional methods of sprouting is that flaxseed has a mucilaginous exudate while germination. This exudate renders the seed extremely sticky and glue-like upon hydration. The subsequent additions of low quantities of water, combined with agitation overcomes the problems previously implicit in sprouting flaxseed using prior art methodology.

During the hydration process, the humidity may be maintained at a low level of about 60% to 90% during the germination process. A humidity of about 65% to 85% is advantageous. Too high of a humidity is not desirable, and thus it is prudent to stay below 100% humidity in the environment of the seeds during the hydration process.

The spouting is allowed to continue for a period of time ranging from until the sprout emerges from the seed, to a period of time in which the sprout is appropriately grown, as described further below for both flax, flax blends and non-flax seeds.

Flax spouts and flaxseed blends may be used as fresh sprouts, as they have enhanced nutritional characteristics compared to unsprouted flaxseed (for example, enhanced Omega-3 fatty acid content), increased stability and shelf life as compared to ground flaxseed products or Omega-3 fatty acid supplemented products, and are good tasting when consumed fresh.

As an alternative to consumption of fresh sprouts or fresh sprout blends, the flax sprouts, blends or other types of sprouted seed may be dried according to an optional aspect of the invention, as described herein.

The drying process occurs at a relatively low temperature for a short duration. Sprouts are exposed to drying temperatures of from about 120 to about 140° F., and preferably from about 125 to 135° F. These temperatures may be used for a period of time ranging from 2 to 8 hours, and preferably from 3 to 6 hours. In order to dry the sprouts, they are spread out, agitated periodically, and exposed to forced air and/or heat. If a forced air flow is used, a drying apparatus such as the Classic Kiln De Cloet (Tillsonburg, Canada), at a level of from about CFW2.000 to about CFM-30.000, or higher, for example at CFM-40.000. A moderate level is preferable. This drying is done at this level so as not to heat the fresh sprouts at a temperature that degrades the quality of the spouts. These drying methods, or others, are incorporated until the moisture content of the sprouts is less than about 6%, and preferably less than about 4.5%.

After the sprouts are adequately dried, the milling process occurs. Milling can be done with any type of mill, for example with a Fritz mill, which has a series of rotating blades through which sprouts pass via gravity. The advantage of grinding with this gravity flow methodology, as opposed to other grinding methodologies that generate heat, is that rancidity of the oils within the sprout is avoided because the temperature does not become elevated due to excessive friction. Optionally, the sprouts (whether flax spouts, flax blends, or other types of sprouts) are ground to a coarse granule size, for optimal incorporation into baked products. The low temperature of the milling environment (below about 65° F.) advantageously allows for a highly acceptable product. The milled product may be referred to herein as a “powder” regardless of whether the product is a coarse grind or fine grind. Either coarse or fine grinds fall within the scope of the invention.

The packaging of the final product may be of any acceptable type, such as for example a Ziplock™ or other type of self-sealing bag, which may be enclosed in a type of packaging acceptable to a consumer. An exterior cotton bag sized to fit an inner plastic bag may be used. Optionally, product information may be attached to such an exterior bag. The milled products so formed may be used to increase the nutritional content (for example, Omega-3 fatty acids and dietary fiber) of baked products, such as breads, muffins, and cooked cereals. Further, these milled products may be added to liquid or semi-solid products such as juices or yogurt. The milled flax product formed in this way has a lengthy shelf life of over 1 year, and the nutritional value of the product supplements many foods that are not high in such components as Omega-3 fatty acids and dietary fiber. A number of other nutritional components are enhanced in flax sprouts as compared to ground flaxseed, as can be seen in the Examples provided herein.

Duration of Sprouting Period. The flax sprouts formed according to the invention are sprouted for a period of time between about ¼ of a day (6 hours) and about 4 days. A flax sprouting period ranging from ½ to 3½ days is an exemplary time period. Once the flaxseeds are wetted and the process of germination starts, the flaxseed sprout can be used with the invention any time after the sprout begins to emerge, which usually occurs at about the 6 to 8 hour point after the first additions of water.

The present invention provides for the production of sprout mixtures with improved shelf life/storage and nutritional content by co-sprouting other seeds with the flaxseeds sprouted according to the invention, or by sprouting other seeds. The production of sprout blends based on germination of seeds in either a mono-culture or multi-culture environment is within the scope of the invention. Sprouts of other types such as fenugreek, soy, red clover, alfalfa, radish, garlic, mustard, onion, broccoli, alfalfa, canola, other brassica family plants, etc., and combinations of these, may be from ⅛ day (3 hours) to 10 days old and mixed with the flax sprouts in any amount, for example in an amount of from 0.5% to 99.5% by weight.

For non-flax seeds which are formed according to the invention, the sprouts may be used at any point from the appearance of the sprout from the germinated seed to the point at which the sprout is up to three times the length of the whole seed itself. The sprouts are generally between about ½ and about 10 days old.

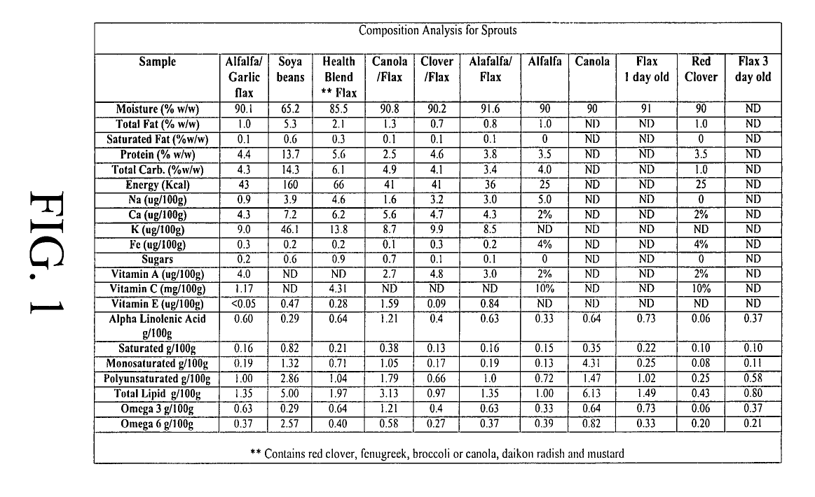

Advantages and Benefits of Flax Sprouts. By growing flax sprouts according to the invention, an elevated Omega-3 fatty acid content can be achieved in the product. FIG. 1 shows some exemplary values of improved levels of Omega-3 fatty acids and other healthy ingredients in flax sprouts and flax sprout mixtures formed according to the invention. These data illustrate the increased levels of Omega-3 and other nutritional components found in sprouts formed according to the invention.

Thus, the product so formed (either as fresh or dried flax spouts) is useful in regulating or effecting various aspects of metabolism for the individual consuming the product. In this way, the products formed according to the invention serve as a medication-free option for regulating health. Additionally, the invention allows for and animal-free food sources for humans or livestock, which is often of concern for vegetarians or under circumstances where consuming animal products is undesirable. The invention may also provide useful crop protection or fruit cleaning protective products.

In addition, the flax sprout powder/extracts produced according to the present invention serve to impart anti-bacterial crop protection. Examples of the anti-bacterial crop protection benefits can be observed in Table 1.

Table 1 illustrates the anti-bacterial (anti-microbial) effect of the Omega-3 rich sprouted flaxseed powder formed according to the invention, and the crop protection benefits that can be realized. Notably, after 24 hours, the flaxseed powder illustrated a protective effect, eliminating 100% of the bacteria applied.

TABLE 1
Anti-bacterial Effect of Sprouted Flaxseed Powder

| | Rate Applied | Rate of |
|---|---|---|
| | to Xanthomonas | Control within |
| | Campestres (Tomato | 24 h (bacterial |
| SAMPLE | bacterial Spot Culture) | elimination) |
| Enriched Flax/Alfalfa | 1000 ppm | 100% |
| Powder** (6.5 g/100 g of | | |
| alfalfa linolenic acid) water | | |
| based extract | | |
| ENRICHED FLAX/ALFALFA | 1000 ppm | 100% |
| POWDER** (MUSILAGE OR | | |
| EXIDATE) FROM WATER | | |
| SOAKED POWDER | | |
| (6.5 G/100 G) | | |
| CONTROL CULTURE | None | 0% |

Note:
1000 ppm equivalent to 1 lb/acre use rate
**Contains 1/3 flax, 2/3 alfalfa powder grown as combined “sprout Omega 3 mixture”

The product formed according to the invention exhibits anti-microbial features and benefits which may be helpful for control of pests such as bacteria or fungi. In this way, the shelf life of a product is improved, compared to ground flaxseed alone, and few (if any) preservatives are required to keep the product fresh for a considerable period of time. The anti-microbial activity of food, plants, or seeds with enriched levels of Omega-3 or Omega-6 fatty acids and other nutraceutical components is not well documented. However, the sprouts and sprout mixtures produced according to the present invention impart improved storage and shelf life to sprouts, relative to those sprouts not known to contain high levels of Omega 3 fatty acids. A shelf life of more than 30 days can be accomplished if sprouts are refrigerated at temperatures of 2-5 degrees Celsius. Examples of the improved shelf life for flax sprout mixtures can be observed from the data presented in Table 2

Table 2 provides exemplary data showing improved shelf life for flax mixtures. In this case, flax is sprouted either alone or is co-sprouted with alfalfa,. clover, canola, garlic or onion. As can be seen from the data, as postsprouting days increase, both refrigerated and non-refrigerated samples deteriorate. However, the presence of flaxseed sprouts improves the shelf life of the mixtures.

TABLE 2
Improved Shelf life for Flax Sprout Mixtures

| | | | | | Non Refrigerated | | | |
|---|---|---|---|---|---|---|---|---|
| | Refrigerated | | | | (room temp) | | | |
| | Days after | | | | Days after | | | |
| | Sprouting | | | | Sprouting | | | |
| | (%) | | | | | | | |
| Sample | 14 | 20 | 30 | 35 | 14 | 20 | 30 | 35 |
| Flax Alfalfa | 0 | 0 | 0 | 5 | 0 | 0 | 10 | 15 |
| Flax Clover | 0 | 0 | 0 | 5 | 0 | 0 | 15 | 20 |
| Flax Canola | 0 | 0 | 0 | 2 | 0 | 0 | 15 | 20 |
| Flax Health | 0 | 0 | 0 | 0 | 0 | 0 | 10 | 15 |
| Blend** | | | | | | | | |
| Flax Only | 0 | 0 | 0 | 0 | 0 | 0 | 10 | 15 |
| Flax Garlic | 0 | 0 | 0 | 0 | 0 | 0 | 20 | 25 |
| Alfalfa Only | 0 | 10 | 30 | 50 | 20 | 50 | 80 | 100 |
| Clover Only | 0 | 15 | 25 | 50 | 40 | 60 | 90 | 100 |
| Canola Only | 0 | 20 | 30 | 50 | 50 | 90 | 100 | 100 |
| Health Blend | 0 | 20 | 30 | 40 | 50 | 100 | 100 | 100 |
| Only | | | | | | | | |
| Onion Only | 0 | 10 | 20 | 40 | 40 | 50 | 60 | 80 |
| Fenugreek Only | 0 | 15 | 20 | 50 | 50 | 60 | 80 | 100 |

****Contains red clover, fenugreek, broccoli or canola, daikon radish and mustard

The product formed according to the invention may be used to provide anti inflammatory, or metabolic regulation benefits to the consumer.

The dried sprout product formed according to the invention has utility as a food, and as a supplement to enrich foods, such as baked goods. When used in baked goods, the flax-based dried sprout product is highly acceptable to the consumer, and helps the baked goods retain moisture, and accomplishes a longer shelf life.

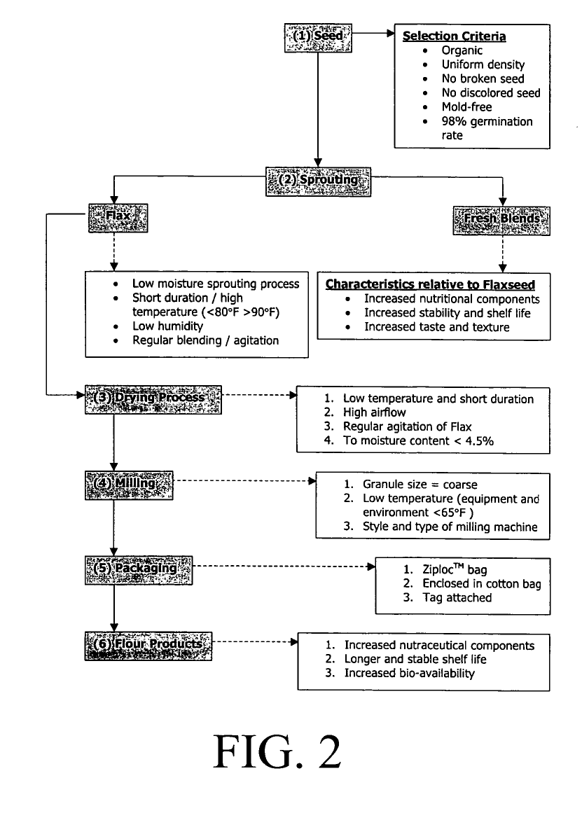

Producing Flax Sprouts. A process for producing flax sprouts is provided herein below, with specific reference to the embodiment shown in FIG. 2. FIG. 2 also illustrates a process for drying flax sprouts using controlled hydration and an air flow drying system, which is optionally included in the process of the invention. If the flax sprouts are dried, a coarse powder can be produced.

Method

According to an alternative embodiment of the invention, sprouts (or sprouts combined with other ingredients, such as berries) can be dried by heating at 53° C. for 24 hours, in the presence of a dessicant or using controlled air flow alone to dry whole flax sprouts. The dried sprouts are then cool down in the dessicator. The dried flax sprouts are grounded in a low speed grinder. Suitable methods for grinding of the products can readily be determined by those skilled in the art. Grinding is may be followed by sieving to produce a uniform flax sprout mesh powder with about 0.5% moisture. This flax sprout powder can be used as a nutraceutically stable food product in itself. Alternatively, the powder obtained can be dry steam distilled to obtain oils, liquid extracts. The sprout powder obtained can alternatively be encapsulated, for example with an enteric coating using cellulose acetate phyhalate.

If an extract of the product is desired, the dried or fresh sprouts can be mixed in water (6.0 g/48 ml, pH 6.5), or an oil, and the mixture centrifuged at 3000 rpm for 10 min. An aqueous supernatant thus obtained can be lyophilized. The freeze dried extract is rich in nutraceutical components such as ALA can be added to solid foods to obtain nutraceutically enriched solid food products. In addition, the supernatant can also be used to obtain nutritionally enriched beverages. In order to obtain nutraceutically enriched beverages, the supernatant of the aqueous extract may be acidified with 1 ml of dilute citric acid solution. The solution thus obtained rich in nutraceuticals can be added to suitable vegetable or fruit base to obtain the desired nutraceutically enriched beverage.

Sprouts from plants other than flax are not known to contain high levels of Omega-3 or Omega-6 fatty acids. Further, such non-flax sprouts normally have a shelf life of 14-20 days if kept refrigerated at temperatures of 2-5 degrees Celsius. The flax sprouts, sprout powders, and extracts formed according to the invention lead to an enhanced shelf-life compared to non-flax sprouts.

Blending of Flax Sprouts with other Food Ingredients or Other Sprout Types. According to the present invention, a variety of ½ to 3½ day old sprouts not known to contain high levels of Omega-3 or Omega-6 fatty acids e.g. alfalfa, red clover, canola (rapeseed), onions, fenugreek (and combinations of various sprouts) are grown as 15 to 30% by weight of ½ to 3½ day old flax sprouts as mixture (organically certified and non organically certified) seed/sprout combinations following the process described herein. Sprout combinations have a higher Omega-3 fatty acid content, which may provide health benefits and improved processing benefits.

Sprouts mixtures/combinations in this way impart improved Omega-3 or Omega-6 fatty acid content, and improved processing benefits to the variety of sprouts not known to contain high levels of such fatty acids.

Co-sprouted sprouts formed from flax mixtures with other seeds formed according to the invention also exhibit high Omega-3 fatty acid enrichment, due to the presence of the sprouted flaxseed.

The flax sprouts formed according to the invention may be blended with other foods, such as processed foods not known to or expected to contain Omega-3 or Omega-6 fatty acids. In this way, powders containing the sprouts or extracts derived from the sprouts may be used as nutraceutical components to supplement foods.

The flax sprouts according to the invention may be dried and ground in any way acceptable in the field of food processing. In this way, powders can be formed having a moisture content of 10% or less, which allows for a longer shelf life than powders having a higher moisture content. According to an embodiment of the invention, the flax sprouts may be dried in a controlled air system that keeps plant cell membranes intact. A dryer such as The Standard Classic Kiln De Cloet (De Cloet, Tillsonburg, Canada) may be used. Once dried, sprouts can be ground and using a low temperature system that does not heat the flax or other sprout types as it grinds.

Flax Product having Elevated Omega-3 or Omega-6 Fatty Acid Content. A variety of Omega-3 and Omege-6 enriched seed varieties such as flax, have defined levels of fatty acids in the whole seed. ALA levels in flaxseed are fairly constant. According to one aspect of the present invention, if such seeds are sprouted at ½ day to 3½ day intervals and then dried and ground up as a coarse powders, or processed as an extract, the combination of early sprouting either with or without the drying process results in nutritional component enrichment over the whole seed alone. An example of the elevated Omega-3 fatty acid levels in sprouted flaxseed is illustrated in Table 3.

Table 3 provides a summary of the lipid content of sprouts formed according to the invention. A comparison is made between flaxseed itself, fresh flax sprouts and flax sprouts which have been dried after either 1.5 days or at 3.5 days post-sprouting. The data illustrate that the fatty acid content of the sprouts is enhanced compared to unsprouted flaxseed.

TABLE 3
Fatty Acid Enrichment Profile in Flax Sprouts

| | Flax Sprouts | | | | | |
|---|---|---|---|---|---|---|
| | | Flax | 1½ | | 3½ | |
| | Flax | Sprouts | day dried | | day dried | |
| Sample | seed | fresh 2 | (g/100 g) | | (g/100 g) | |
| Component level | g/ | days | Sample | Sample | Sample | Sample |
| g/100 g | 100 g | g/100 g | #1 | #2 | #1 | #2 |
| Alpha | 14.0 | 0.73 | 25.0 | 24.3 | 12.6 | 15.2 |
| linolenic acid | | | | | | |
| Saturated | 2.82 | 0.22 | 4.03 | 3.75 | 2.41 | 2.83 |
| Monounsaturated | 4.27 | 0.25 | 7.53 | 7.21 | 3.88 | 4.63 |
| Polyunsaturated | 18.42 | 1.02 | 31.50 | 31.83 | 16.87 | 19.80 |
| Total Lipid | 25.51 | 1.5 | 43.07 | 42.79 | 23.16 | 27.27 |
| Omega 3 | 14.65 | 0.73 | 25.0 | 24.80 | 12.67 | 15.23 |
| Omega 6 | 3.77 | 0.30 | 7.11 | 7.02 | 4.20 | 4.57 |

### EXAMPLE 1

### Flax Sprouting Protocol

The following information is a comparative study of the physical characteristics of flaxseed, milled flaxseed and NUTRASprout™ Flax Powder. The germination of flaxseed presents unique problems to traditional sprouting methodologies. Specific areas of differences are in moisture level, temperature, and humidity. Traditional methodologies would suggest the soaking of the seed for a period of approximately 6 hours in water at approximately 68° F. Due to the mucilaginous nature of flax, this cannot be done.

For example, adding equal quantities of water to seed produces a porridge-like mixture and the seed dies. The ideal protocol for adding moisture to flax is at extremely low ratio of water volume to seed. Water is added in specific volume and time increments over a 24 hour time period. The ratios for seed are as follows based on 10 lbs.

Stage 1:8:00 AM: 10 lbs. Seed-add 500 ml water and agitate seed vigorously until moisture is distributed throughout the mixture.

Stage 2: 9:00 AM: Seed will be clumped together and sticky to the touch. Add 1 liter of water and agitate vigorously until moisture is distributed throughout the mixture.

Stage 3: 11:00 AM: Seed will be caked and porridge-like in consistency. Add 1 liter of water and agitate vigorously until moisture is distributed throughout the mixture.

Stage 4: 4:00 PM: Seed will be caked and porridge-like in consistency. Add 1 liter of water and agitate vigorously until moisture is distributed throughout the mixture.

Stage 5: 8:00 AM: Seed will be caked and porridge-like in consistency. Sticky to the touch and crusty on top. Seed should just be starting to germinate with small white sprouts just beginning to show. Add 1 liter of water and agitate vigorously until moisture is distributed throughout the mixture.

Stage 6: 12:00 PM (Noon): Sprouts will be grown to approximately the same length of the seed and uniformly sprouted. Harvesting and drying should occur at this point.

The total water added over the entire procedure was 4.5 liters per 10 lb of seed.

Temperature: Flax sprouts sprout better at a warmer temperature. Minimum 70° F. to 75° F. with an ideal of 80° F.

Humidity: Minimum 55° F. to 85° F. with an ideal of 75° F. Seed selection is critical. Consistency of colour and density; no malformed or black/broken seeds.

### EXAMPLE 2

### NUTRASprout™ Flax Blends

The production of NUTRASprout™ Blends is based on germination of seeds in mono- and multi-culture environments for enhancement of phytochemicals and antioxidants due to manipulation of moisture content, temperature, time, humidity level, light and aeration. The NUTRASprou™ Blends may be ones in which the flax sprouts are blended with other components, or may simple refer to the pure flax version of the ground sprouts.

For those blends which include sprout types other than flax, one or more non-flax type of seed may be sprouted for ⅛ to 10 days (i.e. alfalfa, red clover, fenugreek, garlic, etc., and combinations of various sprouts), in the presence of flax. The mixture may be are grown as 0.5 to 99.5% by weight of flax as mixture of seed/sprout combinations, which may be either organically certified or non-organically certified. The procedure for growing such sprout combinations is outlined as in Example 1.

Sprouts combinations in this way have improved Omega-3 or Omega-6 fatty acid content, as well as enhanced vitamin, enzyme and lignan content. Consumption of the NUTRASprout™ Flax Blends, improves health and leads to benefits associated with increased consumption Omega-3 or Omega-6 fatty acids.

Examples of improved levels of Omega-3 fatty acds as well as other and dietary components of the composition are indicated in the following tables and graphs.

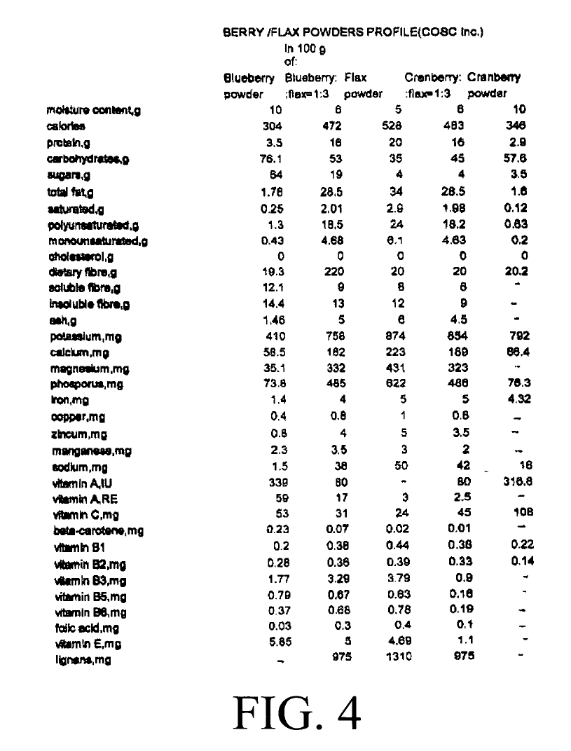

FIG. 4 illustrates the compositional analysis of NUTRASprout™, both on a 48% moisture content (prior to drying) and on a dry weight basis.

Table 4 illustrates NUTRASprout™ physical characteristics in terms of moisture content and weight per unit volume.

TABLE 4
NUTRASprout ™: Physical Characteristics

| | Moisture Content | Volumetric Weight |
|---|---|---|
| | (%) | (g/cm³) |
| Sprouted Flax Powder | 4.60 | 0.55 |
| Blueberry Powder | 8.90 | 0.50 |
| Cranberry Powder (Fine) | 8.70 | 0.46 |
| Cranberry Powder (Coarse) | 8.70 | 0.30 |
| Elderberry Powder | 9.00 | 0.58 |
| Flax/Cranberry Powder (3:1) | 5.37 | 0.47 |
| Flax/Blueberry Powder (3:1) | 5.43 | 0.50 |
| Sprouted Soy Powder | 8.00 | 0.57 |

Table 5 illustrates NUTRASprout™ ground flax sprouts compositional profile in terms of both macronutrient and micronutrient content.

TABLE 5
NUTRASprout ™ Compositional Profile

| | Per | | Per |
|---|---|---|---|
| | 100 g | | 100 g |
| Volumetric Weight (g/cm³) | 0.55 | Vitamin B6 | 0.78 |
| | | (Pyrodoxine) (mg) | |
| Moisture Content (%) | 4.20 | Vitamin B12 | 0.12 |
| | | (Cobalamin) mcg) | |
| Protein (g) | 20.40 | Vitamin C | 23.70 |
| | | (Ascorbic Acid) (mg) | |
| Carbohydrates (g) | 35.40 | Vitamin D (IU) | 20.00 |
| Calories | 510.00 | Vitamin E | 4.69 |
| | | (Tocopherol) (mg) | |
| KJ | 2130.0 | Vitamin K | 5.00 |
| | | (α-Tocopherol) (mcg) | |
| Ash (g) | 6.20 | Choline (mg) | 88.20 |
| Fat (g) | 33.80 | Beta-Carotene | 18.80 |
| Polyunsaturated Fatty Acids (g) | 23.30 | Biotin (mcg) | 33.0 |
| Monounsaturated Fatty Acids (g) | 6.10 | Folic Acid (mg) | 0.40 |
| Saturated Fatty Acids (g) | 2.90 | Lignans (g) | 1.26 |
| Trans Fatty Acids (g) | 0.10 | Peroxide Value (%) | 0.05 |
| Linolenic Acid (g) | 4.90 | Alanine (g) | 1.13 |
| Cholesterol (mg) | 0.00 | Arginine (g) | 2.04 |
| Total Sugars (g) | 4.10 | Asparagine (g) | 2.08 |
| Fructose (g) | 0.50 | Cystine (g) | 0.35 |
| Glucose (g) | 0.10 | Glutamine (g) | 4.18 |
| Sucrose (g) | 3.10 | Glycine (g) | 1.19 |
| Maltose (g) | 0.40 | Histidine (g) | 0.52 |
| Lactose (g) | 0.40 | Isoleucine (g) | 0.96 |
| Total Dietary Fibre (g) | 20.20 | Leucine(g) | 1.32 |
| Insoluble Dietary Fibre (g) | 11.80 | Lysine (g) | 0.92 |
| Soluble Dietary Fibre (g) | 8.40 | Methionine (g) | 0.38 |
| Phosphorous (mg) | 580.00 | Phenylalanine (g) | 1.05 |
| Potassium (mg) | 874.00 | Proline (g) | 0.98 |
| Sodium (mg) | 50.30 | Serine (g) | 1.12 |
| Calcium (mg) | 223.00 | Threonine (g) | 0.81 |
| Iron (mg) | 6.73 | Tryptophan (g) | 0.26 |
| Vitamin A (Retinol) (RE) | 3.00 | Tyrosine (g) | 0.54 |
| Vitamin B₁ (Thiamine) (mg) | 0.44 | Valine (g) | 1.14 |
| Vitamin B₂ (Riboflavin) (mg) | 0.39 | Salmonella | 0.00 |
| Vitamin B₃ (Niacin) (mg) | 3.79 | E. coli 0157: H7 | 0.00 |
| Vitamin B₅ (Pantothenic Acid) | 0.63 | S. aureus | 0.00 |
| (mg) | | | |

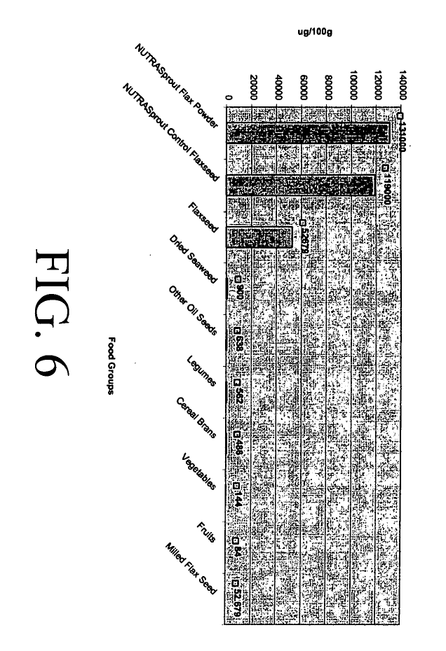

FIG. 6 provides the NUTRASprout™ coarsely ground flax sprout compositional profile for the blueberry and cranberry based flax powders. The berry to flax ratio of these powders are 1:3 on a weight/weight basis.

FIG. 7 illustrates the amino acid profile of flaxseed and sprouted flax powder on a comparative basis.

Table 6 illustrates the vitamin content of flaxseed versus sprouted flax powder formed according to the invention, for selected vitamins.

TABLE 6
Chemical Analysis Comparison: Flaxseed &
NUTRASprout ™ Flax Powder

| | | Flax Powder |
|---|---|---|
| Vitamins | Flaxseed (Dry Weight) | (Dry Weight) |
| Choline | 0 | 8.820 |
| Vitamin B2 (Riboflavin) | 0 | 0.390 |
| Vitamin B3 (Niacin) | 0 | 3.790 |
| Vitamin B5 (Pantothenic Acid) | 0 | 0.630 |
| Vitamin B6 (Pyrodoxine HCI) | 0 | 0.784 |
| Vitamin E | 0 | 4.700 |
| Vitamin C | 2 | 23.700 |

Table 7 illustrates the vitamin content of flaxseed versus sprouted flax powder formed according to the invention, for selected vitamins.

TABLE 7
Chemical Analysis Comparison: Flaxseed &
NUTRASprout ™ Flax Powder

| Vitamins | Flaxseed (Dry Weight) | Flax Powder (Dry Weight) |
|---|---|---|
| Folic Acid | 0 | 0.396 |
| Biotin | 0 | 33.000 |
| Beta Carotene | 0 | 18.800 |

Table 8 provides a comparison of vitamin and micronutrient content between flaxseed and sprouted flax powder formed according to the invention. The values vary slightly form those provided in Tables 8 and 9 due to inter-batch variation.

TABLE 8
Vitamin Comparison

| | | NUTRASprout ™ Sprouted |
|---|---|---|
| Vitamins | Flaxseed | Flax Powder |
| A (RE/100 g) | 0.00 | 3.00 |
| B₁₂ (ug/100 g) | 0.00 | 0.12 |
| B₁ (mg/100 g) | 0.53 | 0.45 |
| B₂ (mg/100 g) | 0.23 | 0.40 |
| B₃ (mg/100 g) | 3.21 | 3.90 |
| B₅ (mg/100 g) | 0.57 | 0.65 |
| B₆ (mg/100 g) | 0.61 | 0.81 |
| Biotin (ug/100 g) | 6.00 | 35.00 |
| Beta Carotene (ug/100 g) | 0.00 | 19.60 |
| Choline (mg/100 g) | 0.00 | 90.20 |
| C (mg/100 g) | 2.40 | 24.60 |
| D (IU/100 g) | 0.00 | 20.60 |
| E (mg/100 g) | 0.05 | 4.88 |
| Folic Acid (mg/100 g) | 0.11 | 0.41 |
| K (ug/100 g) | 0.00 | 5.20 |

FIG. 7 provides the amino acid composition of flaxseed both on a wet and dry weight basis for comparison with sprouted flax and sprouted flax powder formed according to the invention. For most amino acids profiled, the sprouted flax and sprouted flax powder illustrate a higher content than flaxseed either on a wet or dry weight basis.

Table 9 provides a comparison of macronutrient content between flaxseed and sprouted flax powder formed according to the invention. Macronutrients evaluated include fatty acids, sugars and dietary fiber. The sprouted flax powder contains a higher amount of alpha linolenic acid, linoleic acid and total saturated fatty acid relative to the flaxseed.

TABLE 9
Chemical Analysis Comparison: Flaxseed &
NUTRASprout ™ Flax Powder

| | Flaxseed | |
|---|---|---|
| | (Dry Weight) | Flax Powder (Dry Weight) |
| Alpha Linoleic Acid | 21.7 | 23.4 |
| Linoleic Acid | 4.5 | 4.9 |
| Saturated Fatty Acid | 2.7 | 2.9 |
| Total Sugars | 1.6 | 4.1 |
| Insoluble Dietary Fibre | 23.1 | 11.8 |
| Soluble Dietary Fibre | 11.5 | 8.4 |
| Total Dietary Fibre | 34.6 | 20.2 |

Table 10 provides a full lipid analysis for sprouted flax powder formed according to the invention, versus flaxseed based on USDA analysis. The 16:0, 18:1, 20:1, total monounsaturates and total polyunsaturates, as well as total Omega-3 and Omega-6 fatty acid profiles of the flax powder exhibit marked increases compared with unsprouted flaxseed.

Table 11 provides a comparison of the soluble fiber, insoluble fiber and total dietary fiber content of the sprouted flax powder formed according to the invention with other types of foods, in particular: flaxseed and brans. The data obtained is considered on a weight basis relative to flaxseed, and illustrates that the sprouted flax powder formed according to the invention is an excellent source of both soluble and insoluble dietary fiber.

TABLE 10
USDA Flaxseed Analysis Comparison to
NUTRASprout ™ Flax Powder

| | NUTRASprout ™ | USDA Flaxseed |
|---|---|---|
| Lipids | Flax Powder | Analysis |
| 14: 0 | 0.020 | 0.000 |
| 16: 0 | 2.590 | 1.802 |
| 16: 1 | 0.040 | 0.000 |
| 18: 0 | 1.300 | 1.394 |
| 18: 1 | 7.320 | 6.868 |
| 18: 4n3 | 0.000 | 0.000 |
| 20: 1 | 0.080 | 0.000 |
| 20: 4n6 | 0.000 | 0.000 |
| 20: 5n3 | 0.000 | 0.000 |
| 22: 6n3 | 0.000 | 0.000 |
| 22: 1 | 0.060 | 0.000 |
| 22: 5n3 | 0.000 | 0.000 |
| Monounsaturated | 7.510 | 6.868 |
| Polyunsaturated | 32.910 | 22.440 |
| Saturated | 4.110 | 3.196 |
| Omega-3s | 25.950 | 18.122 |
| Omega-6s | 6.960 | 4.318 |

TABLE 11
Fibre Content Comparison

| | | | Total |
|---|---|---|---|
| Food Group | Soluble Fibre | Insoluble Fibre | Dietary Fibre |
| Flaxseed | 10.0 | 30.0 | 40.0 |
| NUTRASprout ™ | 8.4 | 11.8 | 20.2 |
| Sprouted Flax Powder | | | |
| Oat Bran | 8.0 | 8.0 | 17.0 |
| Oatmeal | 5.0 | 6.0 | 11.0 |
| Wheat Bran | 5.0 | 43.0 | 49.0 |
| Rice Bran | 4.0 | 71.0 | 75.0 |
| Corn Bran | 3.0 | 76.0 | 78.0 |

SOURCE: Cereal Food World 38 (10): 755-759 (1993)

Table 12 provides a comparison of the total dietary fiber, soluble fiber, insoluble fiber and moisture content of the sprouted flax and sprouted flax powder formed according to the invention in comparison flaxseed. As with the data in Table 11, these data illustrate that the sprouted flax powder formed according to the invention is an excellent source of both soluble and insoluble dietary fiber.

TABLE 12
Fibre & Moisture Content Comparison

| | Total Dietary | Soluble | Insoluble | Moisture |
|---|---|---|---|---|
| Product | Fibre | Fibre | Fibre | Content (%) |
| NUTRASprout ™ | 20.2 | 11.8 | 8.4 | 4.2 |
| Sprouted Flax Powder | | | | |
| Flax Sprouts | 11.2 | 6.1 | 5.1 | 48.3 |
| Flaxseed | 34.6 | 23.1 | 11.5 | 6.2 |

FIG. 8 provides a comparison of the lignan content of the sprouted flax powder formed according to the invention with sprouted flaxseed (NUTRASprout Control Flaxseed) and unsprouted flaxseed as well as with other types of foods. The sprouted flaxseed formed according to the invention contains a high lignan content by contrast with other foods. The Data used for comparison was obtained in Thompson, L.U. (1995) Flaxseed in Human Nutrition. S.C. Cunnane and L.U. Thompson (Eds). AOCS Press Champain, Ill. 11 pp 219.

Table 13 provides a relative comparison of the amino acid composition of the sprouted flax powder according to the invention with flaxseed, milk, whole egg and the. RDA for each of these amino acids. The sprouted flax powder contains a significant portion of the required RDA for the amino acids listed.

TABLE 13
Amino Acid Comparison

| Essential | | | | NUTRASprout ™ | |
|---|---|---|---|---|---|
| Amino Acids | Flax | Milk | Whole Egg | Flax Powder | RDA |
| Isoleucine | 4.00 | 6.20 | 10.20 | 4.99 | 1.40 |
| Leucine | 7.00 | 11.30 | 18.30 | 6.96 | 2.20 |
| Lysine | 3.80 | 7.50 | 11.30 | 4.78 | 1.60 |
| Methionine | 2.30 | 3.30 | 5.60 | 1.98 | 2.20 |
| Phenylalanine | 5.60 | 5.30 | 10.90 | 5.46 | 2.20 |
| Threonine | 5.10 | 4.60 | 9.70 | 4.21 | 1.00 |
| Tryptophan | 1.90 | 1.60 | 3.50 | 1.35 | 1.00 |
| Valine | 7.00 | 6.60 | 13.60 | 5.93 | 1.60 |

Source: Lab assays completed by Maxxam Analytics Inc.

Table 14 provides an analysis of enzyme activity present in the sprouted flax powder formed according to the invention versus unsprouted flaxseed. Clearly for the protease, cellulase, amylase and lipase enzymes evaluated, sprouted flax illustrates a markedly higher activity than flaxseed.

TABLE 14
Enzyme Comparison

| Product | Protease | Cellulase | Amylase | Lipase |
|---|---|---|---|---|
| Flaxseed | 5.0 | 120.0 | 65.3 | 225.0 |
| NUTRASprout ™ | 48.0 | 960.0 | 83.3 | 950.0 |
| Sprouted Flax Powder | | | | |

Table 15 provides a profile of fatty acid content in a series of batches of sprouts prepared on different dates. The data illustrate that although there is inter-batch variation, the trend in fatty acid profile is remarkably consistent.

TABLE 15
Flax Sprouts Fatty Acid Profile

| | April | July | | | October | October | |
|---|---|---|---|---|---|---|---|
| Fatty Acids (g/100 g) | 1B | 3 | September 4 | October 4 | 12 | 23 | January 1 |
| Monounsaturated Fat | 7.21 | 7.20 | 7.51 | 6.18 | 8.06 | 8.32 | 6.10 |
| Saturated | 3.75 | 3.77 | 4.11 | 4.17 | 4.09 | 4.10 | 2.90 |
| Fat | | | | | | | |
| Omega-3s | 24.80 | 23.08 | 25.95 | 23.20 | 22.87 | 23.34 | 23.30 |
| Omega-6s | 7.02 | 6.05 | 6.96 | 6.33 | 6.17 | 6.25 | 6.10 |

SOURCE:
April to October, 2001 Lab Assays completed by: Lipid Analytical Laboratories January, 2002 Lab Assay completed by: Maxxam Analytics Inc.

### EXAMPLE 3

### Sprouting Seed Types other than Flaxseed

According to the invention, other seed types may be sprouted alone or in combination without including flaxseed in the germination process. Such sprouts are grown until the sprout itself is about 3 times the length of the whole seed, and from there, such sprouts are processed according to the invention.

Table 16 provides data illustrating flavenoid content of day-old soy sprouts.

TABLE 16
Flavenoid Content of Sprouts

| Soy (1 day old sprouts) | | | | Total |
|---|---|---|---|---|
| powdered | | Glyeitin | Genistein | Flavenoids |
| Sample #1 | 594 | 124 | 900 | 1618 |
| Sample #2 | 693 | 80 | 867 | 1640 |

Table 17 provides a summary of the lipid content of soy sprouts, either fresh or powdered, and cranberries either fresh or powdered.

TABLE 17
Lipid Content of Select Sprout Samples

| | Alpha | | | | | | |
|---|---|---|---|---|---|---|---|
| | Linolenic | | | | Total | | |
| Sample | Acid | Saturated | MonounSaturate | Polyunsaturate | Lipid | Omega 3 | Omega 6 |
| Soy Sprouts | 1.34 | 2.80 | 7.04 | 12.98 | 22.8 | 1.36 | 11.62 |
| powdered | | | | | | | |
| Fresh Soy | 0.35 | 0.81 | 1.42 | 3.36 | 5.6 | 0.35 | 3.0 |
| Sprouts | | | | | | | |
| (day old) | | | | | | | |
| Cranberry | 0.56 | 0.35 | 0.31 | 1.25 | 1.91 | 0.56 | 0.69 |
| Powder | | | | | | | |
| Fresh | 0.12 | 0.09 | 0.06 | 0.32 | 0.48 | 0.10 | 0.20 |
| Cranberries | | | | | | | |

### EXAMPLE 4

### Co-Sprouting Flaxseed with Alfalfa

Flaxseed sprouted according to the invention may be co-sprouted with other seed types. In this example, flaxseed was co-sprouted with alfalfa seeds in an “alfalfa blend” originating from 30% flaxseed: 70% alfalfa, by weight.

Table 18 provides a comparison of a lipid profile for fresh alfalfa sprouted in the presence and absence of flax sprouts. When sprouted in the presence of flax, according to the invention, the total lipids, monounsaturated, polyunsaturated and Omega-3 content of the alfalfa-flax mixed sprouts was increased as compared to that of alfalfa sprouts alone. The values shown are based on fresh sprouts.

TABLE 18
Alfalfa And Alfalfa Blend Fatty Acids Profile

| Fatty Acids Profile | Alfalfa | Alfalfa & Flax Blend |
|---|---|---|
| Saturated | 0.16 | 0.16 |
| Monounsaturated | 0.10 | 0.19 |
| Polyunsaturated | 0.74 | 1.00 |
| Total Lipids | 0.99 | 1.35 |
| Omega-3s | 0.34 | 0.83 |
| Omega-6s | 0.40 | 0.37 |

### EXAMPLE 5

### Co-Sprouting Flaxseed with Red Clover

In this example, flaxseed was co-sprouted with red clover seeds in a “red clover blend” originating from 30% flaxseed: 70% red clover, by weight.

Table 19 shows a comparison of a lipid profile for red clover sprouted and dried in the presence and absence of flax sprouts. When sprouted in the presence of flax, according to the invention, the total lipids, monounsaturated, polyunsaturated and Omega-3 content of the red clover-flax mixed sprouts was increased as compared to that of red clover sprouts alone. The values shown are based on dried sprouts.

TABLE 19
Red Clover And Red Clover Blend Fatty Acids Profile

| Fatty Acids Profile | Red Clover | Red Clover & Flax Blend |
|---|---|---|
| Saturated | 0.90 | 1.15 |
| Monounsaturated | 0.72 | 1.38 |
| Polyunsaturated | 1.45 | 5.33 |
| Total Lipids | 3.80 | 7.86 |
| Omega-3s | 0.54 | 3.38 |
| Omega-6s | 1.80 | 1.95 |

### EXAMPLE 6

### Producing Baked Products with Sprouted Flaxseed Powder

In this example, sprouted flaxseed powder was formed according to Example 2, and was included in a conventional recipe for bagels and bread. In each recipe, the sprouted flaxseed powder was included as a substitute for 20% of the flour content of the recipe on a 1:1 volume basis.

Table 20 provides a comparison of Omega-3 and Omega-6 fatty acid content between bread and bagels produced containing sprouted flaxseed powder according to the invention with a control bread product baked without the sprouted flax powder. Both bread and bagel products (the first two columns) containing the sprouted flax powder show increased content of these fatty acids. The products formed with the sprouted flax powder are of acceptable quality, and have been reported to be very palatable on the basis of anecdotal evidence. Further, the products containing the flaxseed powder showed increased shelf life and maintained the moisture content better than the conventional bread or bagel product.

TABLE 20
NUTRASprout ™ Flax Powder Breads EFA Content

| Essential Fatty Acids | Bread | Bagels | Control Bagel |
|---|---|---|---|
| Omega-3s | 2.859 | 0.802 | 0.041 |
| Omega-6s | 2.498 | 0.597 | 0.497 |

The above-described embodiments of the invention are intended to be examples of the present invention. Alterations, modifications and variations may be effected the particular embodiments by those of skill in the art, without departing from the scope of the invention which is defined solely by the claims appended hereto.

What is claimed is:

1. A process for preparing flax having an elevated level of an Omega-3 fatty acid compared to flaxseed, comprising the step of sprouting flaxseed for at least 6 hours.

2. The process according to claim 1 wherein alpha linolenic acid (ALA) is the fatty acid having an elevated level.

3. The process according to claim 1 additionally comprising the step of drying the sprouted flaxseed.

4. The process according to claim 3 wherein the step of drying comprises a controlled air drying process.

5. The process according to claim 1 wherein the sprouting of flaxseed occurs for a period of time of from about 12 to about 84 hours.

6. A flax product having a higher level of an Omega-3 fatty acid compared to flaxseed, said product comprising flaxseed sprouted for at least 6 hours.

7. A supplement comprising the flax product according to claim 6 dried to have a moisture content of about 5%.

8. A supplement comprising the flax product according to claim 6 in an amount of from 0.5% to 99.5% by weight.

9. The supplement of claim 8 additionally comprising a sprout from a seed other than flaxseed.

10. The supplement of claim 9, wherein the seed other than flaxseed is selected from the group of seeds consisting of fenugreek, soy, red clover, alfalfa, radish, mustard, onion, garlic, broccoli, alfalfa, canola, other brassica family plants, and combinations thereof.

11. The supplement of claim 7 additionally comprising a dried fruit component.

12. The supplement according to claim 7 for use as a nutraceutical human supplement or as an animal food supplement.

13. The supplement according to claim 8 for use as a nutraceutical human supplement or as an animal food supplement.

14. The supplement according to claim 9 for use as a nutraceutical human supplement or as an animal food supplement.

15. The supplement according to claim 10 for use as a nutraceutical human supplement or as an animal food supplement.

16. The supplement according to claim 11 for use as a nutraceutical human supplement or as an animal food supplement.

17. A process for sprouting flaxseed where the flaxseed is germinated by hydration with a plurality of separate additions of water, agitating flaxseed between additions of water, and permitting sprouting for at least 6 hours.

18. The process according to claim 17 wherein flaxseed is sprouted in the presence of seed of other plants.

19. The process according to claim 18 wherein the seed of other plants is selected from the group consisting of fenugreek, soy, red clover, alfalfa, radish, garlic, mustard, onion, broccoli, alfalfa, canola, other brassica family plants, and combinations thereof.

20. A flax product comprising a supplement according to claim 7 having the form of a capsule or tablet.

21. A flax product comprising a supplement according to claim 8 having the form of a capsule or tablet.

22. A flax product comprising a supplement according to claim 9 having the form of a capsule or tablet.

23. A flax product comprising a supplement according to claim 10 having the form of a capsule or tablet.

24. A flax product comprising a supplement according to claim 11 having the form of a capsule or tablet.

25. A process of preparing a flax product comprising the steps of: (a) sprouting a flaxseed by hydrating with a plurality of discreet additions of water, to thereby form a sprout; (b) drying the sprout to a moisture content of less than about 5%, thereby forming a dried sprout; and (c) milling the dried sprout at a temperature below 65° F.

26. A process of preparing a dried sprout product comprising the steps of: (a) sprouting said seed to a point where the sprout is less than about 3 times the length of an unsprouted seed, thereby forming a sprout; (b) drying the sprout to a moisture content of less than about 5%, thereby forming a dried sprout; and (c) milling the dried sprout at a temperature below 65° F.
